(19) United States
(12) Patent Application Publication
(10) Pub. No.: US 2011/0156898 A1
(43) Pub. Date: Jun. 30, 2011

(54) ENVIRONMENT SENSING SYSTEM FOR THE HEARING-IMPAIRED

(76) Inventors: Eric Taillefer, Quebec (CA); Sylvie Durand, Quebec (CA); Normand Gagnon, Quebec (CA); Michel Peladeau, Laval, Quebec (CA); Lionel Rochette, Quebec (CA)

(21) Appl. No.: 12/517,958

(22) PCT Filed: Nov. 26, 2007
(86) PCT No.: PCT/CA07/02126

§ 371 Date: Mar. 1, 2011

Related U.S. Application Data
(60) Provisional application No. 60/869,129, filed on Dec. 8, 2006.

(51) Int. Cl. G08B 1/08

(52) U.S. Cl. 340/539.11

(57) ABSTRACT

There is provided an environment sensing system for the deaf/hearing-impaired. A user wears a personal unit for notifying him/her of a sound event in its surrounding environment. The personal unit is also in communication with a central station, for the user to request immediate assistance. When receiving a sound event message from a sound detection unit in the environment, the personal unit vibrates and displays a notification on a screen. At any time, the user may request immediate assistance to the central station using push buttons located on the personal unit. The central station may contact the user by displaying inquiries or messages on the screen. The user may then confirm that immediate assistance is actually required or communicate more information to the central station using the push buttons.

### CROSS-REFERENCE TO RELATED APPLICATIONS

The present application claims priority of U.S. provisional patent application No. 60/869,129 filed on Dec. 8, 2006.

### TECHNICAL FIELD

The description relates to an environmental sensing system for the deaf or hearing-impaired. More particularly, the description relates to a personal unit to be carried by a hearing impaired user for notifying the user of a sound event detected in its surrounding environment.

### BACKGROUND

Several environmental sensing systems for the deaf or hearing-impaired have been introduced on the market in recent years. An environmental sensing system provides the deaf or hearing-impaired with better autonomy and improved sense of security by detecting sound events in their immediate environment, i.e. their house. Various detection units are installed around the house. The detection units may comprise a door bell detector, a fire alarm detector, a phone ring detector, a sound detector, etc. Each detection unit has a wireless transmitter for transmitting a signal to the portable receiver worn by the user, close to his/her body. When the portable receiver receives a signal from one of the detection units, it warns the user with a vibration. The receiver typically has light indicators with a symbol or a word underneath for indicating which detection unit generated the signal (e.g. four lights for “door”, “fire”, “phone” and “sound”).

Furthermore, International Application published with number WO 96/36301 A1 describes an environmental sensing system wherein the user may call an emergency phone number for immediate assistance using its portable receiver. The portable receiver simply has a push button for calling an emergency number for immediate assistance.

In prior art security systems, central security services generally place a phone call to the customer in order to make sure that the emergency call was not intentional before sending the police. The deaf or hearing-impaired customers may be called using a telephone typewriter for example.

Presently available environmental sensing systems are fixed systems installed in the house and which operate inside or within close proximity to the house. Consequently, the improved sense of security provided by the system when the user is home may emphasize the reduced sense of security when the user is away from home.

### SUMMARY

There is provided an environment sensing system for the deaf/hearing-impaired. A user wears a personal unit for notifying him/her of a sound event in his/her surrounding environment. The personal unit is also in communication with an auxiliary service, i.e., a central station, for the user to request immediate assistance. The personal unit has a transceiver for receiving a sound event message from a sound detection unit in the surrounding environment. When receiving a message, the personal unit vibrates and displays a notification on a screen. At any time, the user may request immediate assistance to the central station using push buttons located on the personal unit. The central station may contact the user through its personal unit by displaying inquiries or messages on the screen. The user may then confirm that immediate assistance is actually required or communicate more information to the central station using push buttons.

According to one aspect, there is provided a personal unit for notifying a deaf/hearing-impaired user of a sound event in its surrounding environment and for communicating an immediate assistant request to a central station. The personal unit has a transceiver for receiving a sound event message representative of the sound event detected in the environment, an output module for notifying the user of the sound event message, and an input module for inputting the immediate assistance request. The request is communicated to the central station using the transceiver. The transceiver is also used for receiving an inquiry message initiated by the central station in response to the request. The inquiry message is to be displayed on the output module. An answer to the inquiry message can be inputted using the input module and communicated to the central station using the transceiver.

According to another aspect, there is provided a method for communicating an immediate assistance request to a central station using a portable personal unit for notifying a deaf/hearing-impaired user of a sound event in its surrounding environment. A sound event message representative of the sound event detected in the environment is received on the portable personal unit. The sound event message is being notified to the user on the portable personal unit. An immediate assistance request is inputted on the portable personal unit. The request is communicated to a central station. An inquiry message initiated by the central station in response to the request is received on the portable personal unit. The inquiry message is being displayed on the portable personal unit. An answer to the inquiry message is manually inputted by the user on the portable personal unit. The answer is transmitted to the central station.

According to another aspect, there is provided a portable personal unit for notifying a deaf/hearing-impaired user of a sound event in its surrounding environment and in communication with a detection unit having a unique identification code. The personal unit has a register for listing registered identification codes. The personal unit also has a transceiver for receiving a sound event message representative of a sound event detected in the environment. The sound event message comprises the unique identification code and the transceiver considers the sound event message only if the unique identification code is listed in the register. The personal unit also has an output module for notifying of the considered sound event message, and an input module for adding and removing registered identification codes from the register.

According to another aspect, there is provided a method for using a portable personal unit with at least a first and a second sound event detection systems. The personal unit is for notifying a deaf/hearing-impaired user of sound events in its surrounding environment. The portable personal unit is programmed to communicate with units of the first sound event detection system. The portable personal unit is moved in a surrounding environment of the second sound event detection system. The first and the second sound event detection systems have non-overlapping surrounding environments. The portable personal unit is programmed to communicate with existing units of the second sound event detection system such that the portable personal unit remains allowed to communicate with units of the first sound event detection system. The portable personal unit can thus be moved between the surrounding environments of the first and the second sound event detection systems for interchangeably using the portable personal unit with the first and the second sound event detection systems.

There is provided a personal unit for notifying a deaf/hearing-impaired user of a sound event in its surrounding environment and in communication with a detection unit having a unique identification code. The personal unit has a register for listing unique identification codes and is able to learn different environmental sensing systems by adding identification codes to its register. The personal unit is thus transportable for use with other environmental sensing systems such as one installed at work for example. Furthermore, a detection unit can be transported along with the personal unit so that the user may use the environmental sensing system when he/she is neither home nor at work. For example, the system may be used in a hotel room. Preferably, the system also comprises a transportable bedside unit that can be installed on any bed when the user is not home. The bedside unit is for waking up the user in case of a sound event in the hotel room. The unique identification code also provides an encryption preventing interferences between other systems in the neighborhood.

### BRIEF DESCRIPTION OF THE DRAWINGS

FIG. 1 is a block diagram illustrating an environment sensing system for the deaf or hearing-impaired;

FIG. 2 is a block diagram illustrating a personal unit for use in the environment sensing system of FIG. 1;

FIG. 3 comprises FIG. 3A to FIG. 3K and shows various icons that can be displayed on the personal unit of FIG. 2;

FIG. 4 is a block diagram illustrating an auxiliary unit which can be used as a sound detection unit, an electrical detection unit or an external device controlling unit in the environment sensing system of FIG. 1;

FIG. 5 is a block diagram illustrating a bedside unit for use in the environment sensing system of FIG. 1;

FIG. 6 is a block diagram illustrating a central station interfacing unit for use in the environment sensing system of FIG. 1;

FIG. 7 is a flow chart illustrating a method for communicating an immediate assistance request to a central station using a personal unit;

FIG. 8 is a block diagram illustrating the programming of the personal unit of FIG. 2 to function in a plurality of environment sensing systems; and

FIG. 9 is a flow chart illustrating the programming of the personal unit of FIG. 2 to function in a plurality of environment sensing systems.

It will be noted that throughout the appended drawings, like features are identified by like reference numerals.

### DETAILED DESCRIPTION

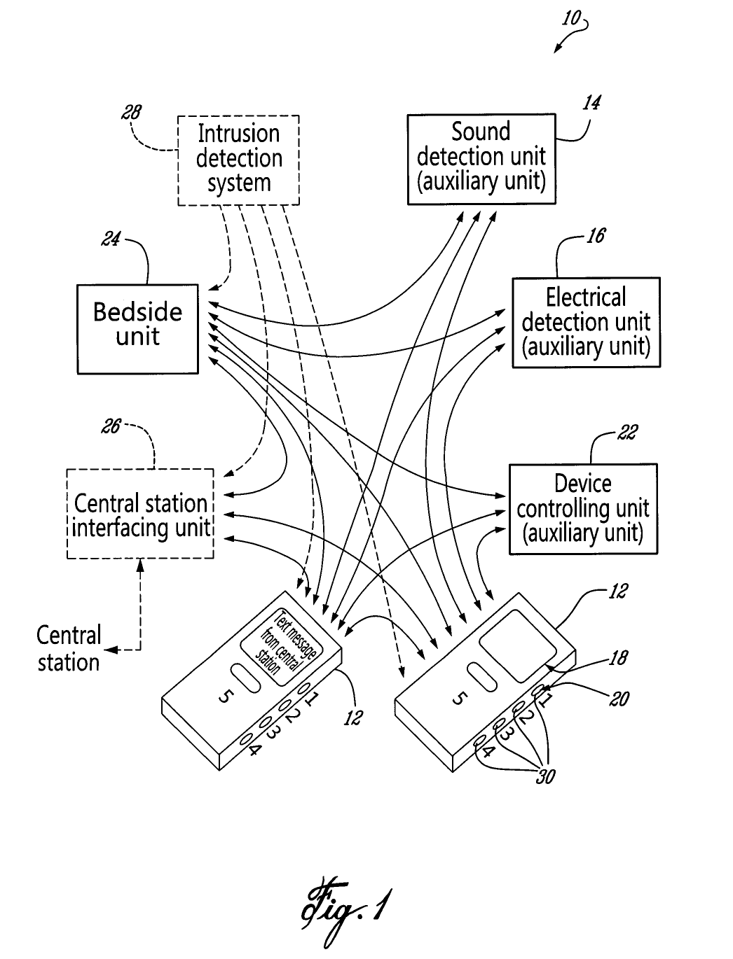

Now referring to the drawings, FIG. 1 illustrates an environment sensing system 10 for the deaf or hearing-impaired. The environment sensing system 10 comprises one or more personal units 12 (the embodiment of FIG. 1 having two personal units 12) to be worn by a deaf/hearing-impaired user, close to his/her body, for notifying the user of a sound event in his/her surrounding environment, his/her house or his/her workplace for instance.

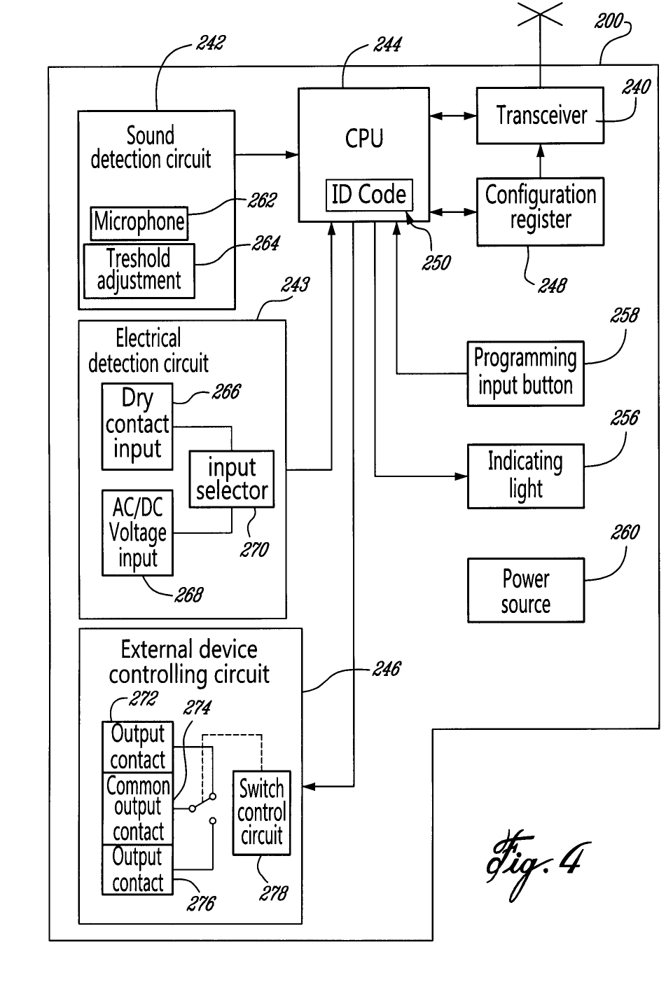

One or more sound detection units 14 and electrical detection units 16 are distributed in the surrounding environment. Sound and electrical detection units 14 and 16 include one or a plurality of this non exhaustive list: a door bell detector, a fire alarm detector, a phone ring detector, a baby cry detector, a sound detector. While all of the listed detectors could operate by sound detection, e.g. by the use of microphone detection means, most of the detectors are actually electrical detector units 16 that do not rely on audio detection to operate. For example, in one configuration, the door bell detector is an electrical detection unit 16 comprising two electrical ports to be connected to the door bell. As one activates the door bell, a contact is created between the two ports and a door bell event is detected by the electrical detection unit 16. Although the detection is not directly based on audio detection, most of the electrical detection units 16 can still be considered as detecting a sound event in the surrounding environment of the user. A sound event is an event that would normally be notified to a non-deaf or hearing-impaired by way of an audio signal, including a fire alarm, a door bell and also an intrusion in the house, which a non-deaf or hearing-impaired would possibly be able to hear. Other detection units could also or alternatively be used in the system. For example, the system could include a gas detector to warn a user of a gas leakage in industrial applications. Accordingly, the system could find applications beyond the hearing-impaired. The sound detection unit 14 and the electrical detection unit 16 will be described in more detail hereinbelow with reference to FIG. 4.

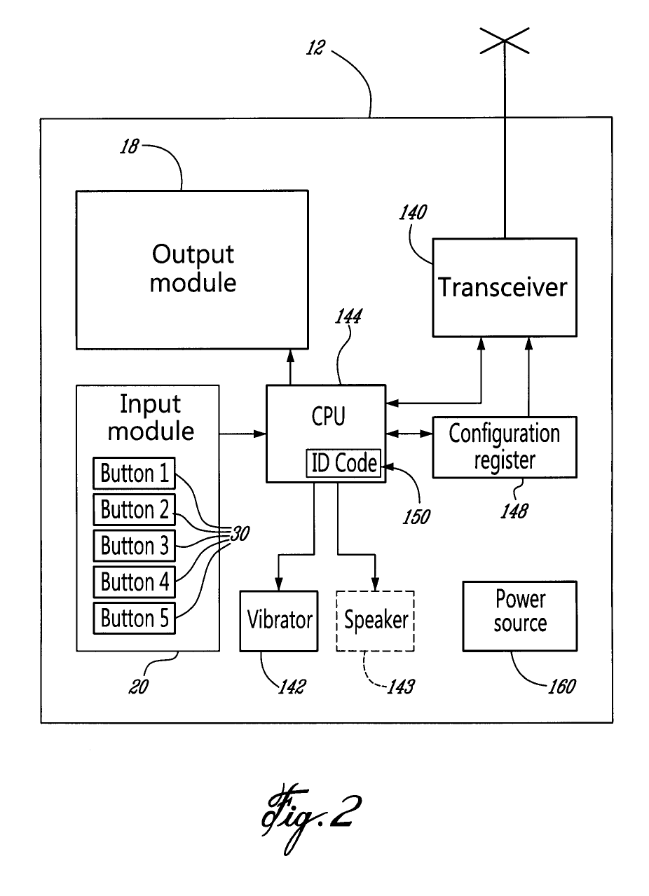

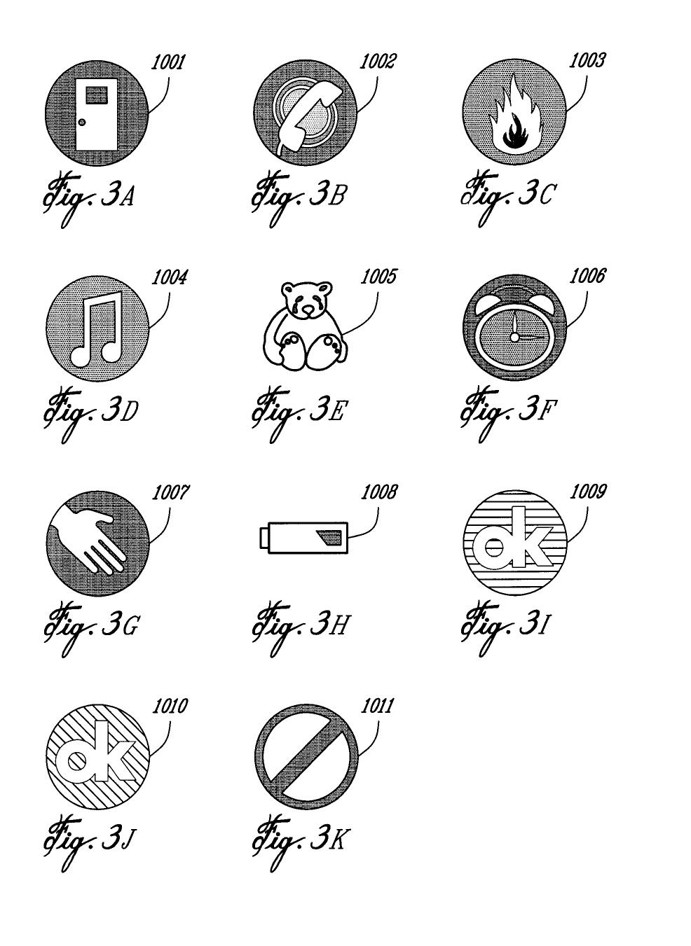

Any time an event is detected by a sound detection unit 14 or an electrical detection unit 16, the given detection unit sends an event message corresponding to the event using an internal transceiver. The personal unit 12, or both personal units 12 in the case of the illustrated system, receives the event message using its own transceiver. Each personal unit 12 has a vibrator for indicating to the user that a message has been received and has an output module 18, typically a display screen, for displaying a notification corresponding to the event message. The notification is made by displaying the appropriate icon selected among a list of illustrative icons (see FIG. 3), the icon providing the identification of the specific detection unit 14 or 16 that sent the message. The personal unit 12 will be described in more detail hereinbelow with reference to FIG. 2.

The environment sensing system 10 may optionally comprise one or a plurality of the device controlling unit 22 for controlling the activation of electrical equipment around the house such as for switching a lamp on and off and for opening or closing a garage door. The device controlling unit 22 is activated using an input module 20 of the personal unit 12.

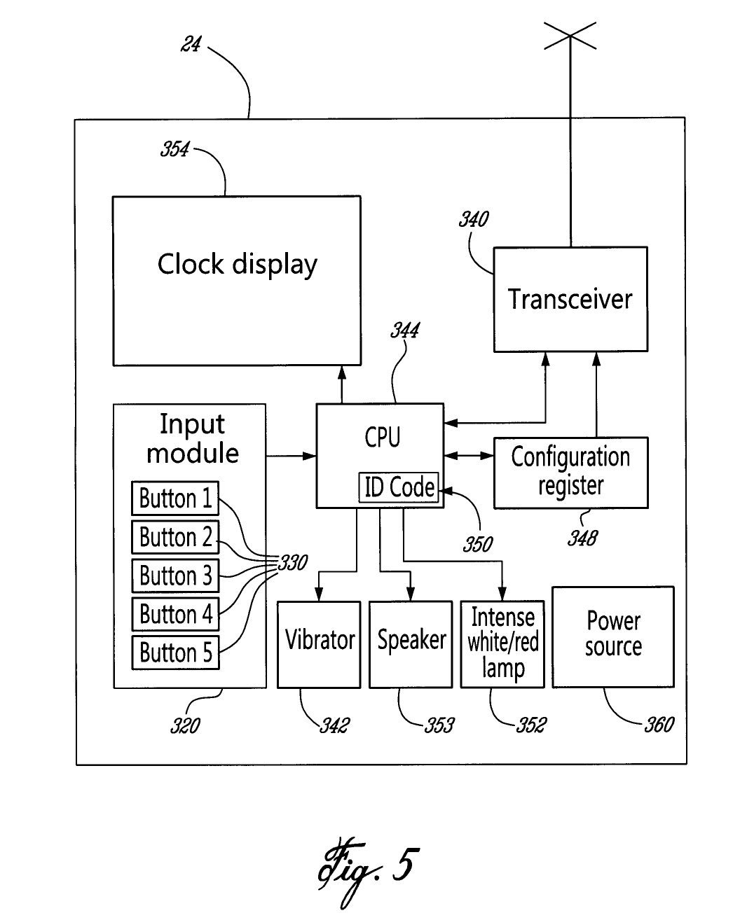

A bedside unit 24 is typically located next to the bed of the user and also receives the sound event messages provided by the sound detection units 14 and electrical detection units 16. The bedside unit 24 comprises a vibrator located in or under the bed of the user and an intense lamp, both for waking the user in case of a sound event. The bedside unit 24 will be described in more detail hereinbelow with reference to FIG. 5.

According to an embodiment, the personal unit 12 includes an input module 20 that consists of five push buttons 30, i.e. four on the side and a fifth one on the top. The specific function of each button will be described hereinbelow.

Optionally, the user may subscribe to a central assistance service which allows the user to request immediate assistance to an auxiliary service, i.e., a central station, at any time using the input module 20, i.e. push button 2 located on the personal unit 12. Accordingly, a request message is transmitted to a central station interfacing unit 26 using the personal unit transceiver. The central station interfacing unit 26 contacts the central station using a phone line (e.g. a telco landline or a long range wireless, such as cellular) or an internet connection. In response to the request, the central station may contact the user through his/her personal unit 12 by displaying inquiries or messages on the output module 18. The inquiries will typically consist of multiple-choice questions that can be answered by pressing the push button of the input module 16 corresponding to the answer. An exemplary question is: “Please confirm that you require the police to come to your place. Press 2 to confirm, press 3 to request a different assistance, or press 4 to cancel the request”. The user may then confirm that immediate assistance is actually required using the push buttons of the input module 20 or communicate the problem initiating the request for receiving adapted assistance. This affirmative message from the central station can be used to reassure the user: “Police were advised and should be there in 5 minutes”.

Optionally, the environmental sensing system 10 may comprise an intrusion detection system 28 for detecting the intrusion of a burglar in the house or workplace during the night or when there is nobody there. The intrusion detection system 28 typically detects an infraction, opening or breaking of a door or a window. Any time an intrusion event is detected, an intrusion event message is automatically sent to the personal unit 12 and the bedside unit 24 to alert the user. The intrusion event message is also automatically sent to the central station interfacing unit 26 for requesting immediate assistance. The central station receiving the message may then communicate to the user to confirm that immediate assistance is required and the user may answer to cancel the request if the intrusion detection system was inadvertently activated (e.g., the user failed to disabled it in the morning or when getting home for example). The confirmation protocol may vary and should be part of an agreement between the user and the central assistance service.

The intrusion detection system may also comprise a motion detection system to detect an unwanted presence in the house/workplace when there should be nobody there. The motion detection system should be disabled when people are in and sleeping during the night as the system could be very easily activated accidentally.

Every personal unit 12 of the system independently receives all event messages and may be used independently to control the device controlling unit 22 or to request immediate assistance. If a plurality of personal units 12 is present around the house or the surrounding environment, the personal units 12 may be used for the different users to communicate with one another as will be described hereinbelow.

FIG. 2 illustrates a personal unit 12 for use within the environmental sensing system 10. The personal unit 12 uses bidirectional wireless technology to receive all event messages from the different detection units 14, 16 and thereby monitors events occurring in its surrounding environment. The personal unit 12 comprises a transceiver 140 for transmitting and receiving messages, a vibrator 142 for warning the user of the reception of a message, a central processing unit (CPU) 144 for managing the operation of the various components as a function of the input and received messages, an input module 20 having push buttons 146 for a user to input requests and acknowledgments, an output module 18 for displaying notifications corresponding to received messages, a configuration register 148 for saving the system configuration and a power source 160 for powering each component of the personal unit 12.

The transceiver 140 provides a communication range of about 100 m with any other unit of the system. The transceiver 140 receives event messages from the various detection units 14, 16, communicates immediate assistance requests and local assistance request and receives inquiry messages from the central station in response to an immediate assistance request. Furthermore, the transceiver 140 synchronizes data with the CPU 144 and awakens the CPU 144 from a sleep mode upon reception of a message. The transceiver 140, like all other transceivers of the environmental sensing system 10, is further used as a repeater for retransmitting any message received in order to increase the range covered by the system. This functionality expands the coverage zone of the environmental sensing system 10 beyond the 100-m communication range, the only requirement being that each fixed unit is located within a 100-m range of another fixed unit.

According to an embodiment, the input module 20 comprises five push buttons 30, four on the side of the unit (numbered 1 to 4), and one on the top (numbered 5). By pressing button 1, a first user requests local assistance from a second user also having a personal unit 12 and who is in the communication range of the system. A message is then sent by the first personal unit 12, of which button 1 was pressed, and is received by the second personal unit 12. The second personal unit 12 then vibrates to warn the second user that a message was received and an appropriate notification (see FIG. 3G) is displayed on the output module 18 of the second personal unit 12 for the second user to visually notice that the first user requests assistance.

By pressing button 2, the user communicates an immediate assistance request to the central station through the central station interfacing unit 26 (see FIG. 1).

By pressing button 3, the user requests medical assistance to the central station. The central station will appoint the appropriate resource depending on the request made, i.e. immediate assistance or medical assistance.

Button 4 is an acknowledgement of receipt button. Button 4 is used by the user to acknowledge to a detection unit that an event message was received.

Finally, button 5 (top) is programmed as an “intuitive” action button to take action in response to a local event (e.g., a clock alarm event) or to send an acknowledge response on an event displaying a simple “Ok?” icon. When the network is at idle, this button also awaken the unit (if in sleep mode), and displays a real time clock on the output module 18.

The input module 20 is also used to activate the device controlling unit 22 (see FIG. 1). Up to two device controlling units can be used in this embodiment. A first device controlling unit 22 is activated by pressing buttons 1 and 3 simultaneously and a second device controlling unit 22 is activated by pressing buttons 2 and 4.

When the central station communicates with the user through the personal unit 12, predefined responses are displayed on the output module 18. Buttons 1 and 4 are used to scroll up and down while buttons 2 and 3 are used to shift left and right to highlight the appropriate response. Button 5 (top) is then used to select the response to be transmitted.

When an event is detected by a sound detection unit 14 or an electrical detection unit 16, the detection unit is activated and sends a corresponding event message. When receiving a message from any of the sound detection units 14 or electrical detection units 16 or from another personal unit 12, the vibrator 142 is activated for indicating the user that a message has been received. In this embodiment, each type of event message has a specific vibration sequence.

A door bell generates one short vibration.

A phone ring generates two consecutive vibrations.

A fire alarm generates three vibrations.

A general sound generates four vibrations.

Baby cries generate five vibrations.

It will be understood that the vibration sequences may be different in other embodiments. The vibration sequences could also be customized.

Furthermore, a notification corresponding to the message received is displayed on the output module 18 for the user to better identify the unit 12, 14 or 16 from which the message originates. The notification is made using the color display of one icon among the icons shown in FIG. 3A to FIG. 3G. The user then holds top button 5 for two seconds in order to acknowledge the receipt of the message and icon of FIG. 3I is displayed on the output module 18. When the detection unit 14 or 16 that generated the message receives the acknowledgement, the icon of FIG. 3J is displayed to confirm the acknowledgement. It is noted that only one personal unit 12 needs to acknowledge the receipt of the message for the detection unit 14 or 16 to cancel the event.

The output module 18 is also used to display inquiries or messages from the central station. Text, image or a combination thereof can be used by the central station to communicate with the user.

In this embodiment, the output module 18 is a small molecular organic light-emitting diode (OLED) display screen providing the display of 262,000 colors on a screen of 128×128×3 pixels having a diagonal dimension of 1.3 inch. The response time of the screen is about 10 μs. The OLED screen provides an operating range of −20 to 70° C.

FIG. 3 shows the various icons that can be displayed on the output module 18.

FIG. 3A shows the icon 1001 used for notifying a door bell event.

FIG. 3B shows the icon 1002 used for notifying a phone ring event.

FIG. 3C shows the icon 1003 used for notifying a fire alarm event.

FIG. 3D shows the icon 1004 used for notifying a general sound event.

FIG. 3E shows the icon 1005 used for notifying a baby cry event.

FIG. 3F shows the icon 1006 used for notifying a clock alarm event. As will be described hereinbelow, up to nine clock alarms can be programmed in the personal unit 12 using the input module 18.

FIG. 3G shows the icon 1007 used for notifying a local assistance request event.

In addition to the above message notification icons, other icons are used for management.

FIG. 3H shows the icon 1008 used for notifying a low battery level of the power source 160 of the personal unit 12.

FIG. 3I shows the icon 1009 displayed after the user acknowledges the receipt of an event message using the input module 18. Not noticeable on the drawing is that this icon is blue.

FIG. 3J shows the icon 1010 displayed to confirm to the user that the detection unit 14-16 received the acknowledgment of receipt of an event message. This icon is very similar to the icon of FIG. 3I but, not noticeable on the drawing, this icon is green.

FIG. 3K shows the icon 1011 displayed to notice the user that the personal unit 12 is out of range and that messages sent by the detection unit will not be received.

Each unit, including sound detection units 14, electrical detection units 16, the personal units 12 and the bedside unit 24, has a unique identification (ID) code. In this embodiment, the unique ID code 150, 250, 350 and 450 (see FIGS. 2, 4, 5 and 6) is provided by the unique serial number of the CPU of the unit, but the ID code could also be recorded otherwise. This code is used to encrypt the exchanged messages such that only messages from units pertaining to the environment sensing system 10 are received. Each unit uses a configuration register 148 for listing in memory the ID codes of the other units of the system 10. The register contains the ID code of all units susceptible to communicate with each other. The personal unit 12 considers messages received from and only from the registered units. As will be described hereinbelow, each unit is able to learn new personal units 12, detection units 14 or 16 and different environmental sensing systems using a simple procedure which adds ID codes in the configuration register 148. During this procedure, each ID code is associated with a specific icon selected by the user for suitable notification. This procedure is described hereinbelow.

In order for a same personal unit to be used interchangeably with different environmental sensing systems, the configuration register 148 of the personal unit 12 may include units located in different environmental sensing systems 10, even if all those units are not simultaneously in the communication range of the personal unit 12.

Consequently, the personal unit 12 is transportable for use with other environmental sensing systems such as one installed at home and one installed at work. Furthermore, a detection unit 14 or 16 can be transported along with the personal unit 12 so that the user can use a basic environmental sensing system when he/she is neither home nor at work. For example, the sub-system may be used in a hotel room. In order to avoid interference between environmental sensing systems in a proximate neighborhood, the transceiver 140 only accepts event messages from units registered in the configuration register 148.

Finally, a CPU 144 controls the operation of the various components as a function of the input and a power source 160 supplies power to all the components of the personal unit 12. The CPU 144, along with the transceiver 140, manages receipt and transmission of messages. Furthermore, the CPU 144 holds a clock and a calendar, reads the input module 20, checks battery level, checks transceiver's 140 status, awakens the transceiver 140 when transmission is required and activates the vibrator 142 when required. The CPU 144 and the transceiver 140 communicates using a universal asynchronous receiver transmitter (UART) with, typically, a speed of 57,600 bps. The CPU 144 communicates with the output module 18 using a four-wire integrated serial peripheral interface (SPI). The screen of the output module 18 is turned off when there is no notification to display. Each push button 30 is connected to one port of the CPU 144. Activation of a push button 30 also awakens the CPU 144 from its sleep mode. The vibrator 142 is connected to a separate port of the CPU 144 though a transistor switch. The CPU is typically a commercially available microprocessor manufactured by ZiLOG typically with a 20 MHz clock but any suitable CPU by the same or another manufacturer can alternatively be used. In this embodiment, the power source 160 is a 2/3AA 3.6 V lithium battery (TL-5955). The battery can last up to six months but eventually needs to be replaced. When the battery level becomes quite low, the icon of FIG. 3H is displayed on the output module 18 to warn the user that the battery needs to be replaced. A low battery level also results in a reduced communication range. A rechargeable battery could also be used and could be recharged using a recharging station provided with the bedside unit 24 for example. The CPU 144, the transceiver 140 and the output module 18 all have a sleep mode for saving battery power. Both awaken from the sleep mode when receiving a message or when top button 5 is pressed.

The personal unit 12 may further have a speaker 143 for producing audible tones in sync with the vibrator 142. This is used, for example, when multiple personal units 12 are in the same environmental sensing system 10 where some users are deaf or hearing-impaired, and some are not deaf or hearing-impaired.

The input module 20 is also used to adjust the time of up to nine clock alarms in the personal unit 12. The programming and management of the clock alarms are provided by the internal Real Time Clock in the CPU 144. For programming a clock alarm, the user holds button 4 for five seconds. The output module 18 then displays an “OK” icon, followed one second later by the general menu. The user then selects the menu option “clock alarm” using buttons 1 to 4 to scroll the menu options and presses top button 5 to confirm the “clock alarm” selection. The reference numerals (one to nine) of the clock alarms are scrolled (with a roll-over) using buttons 1 to 4 as follow: Button 1 for the tenth of hour digit (from 0 to 2); Button 2 for the hour digit (from 0 to 9—or from 0 to 3 if the tenth of hour digit is already set to 2); Button 3 for the tenth of minute digit (from 0 to 5); Button 4 for the minute digit (from 0 to 9); and Button 5 to confirm a selection.

The time and date of the clock are adjusted using a similar procedure (with a separate step—a scroll list—to adjust the year).

FIG. 4 illustrates an auxiliary unit 200 which can be used either as a sound detection unit 14, an electrical detection unit 16 or an external device controlling unit 22 in the environmental sensing system 10. Sound detection, electrical detection and device control functionalities are typically all integrated in the auxiliary unit 200. The loaded configuration differentiates their use.

The auxiliary unit 200 thus comprises a sound detection circuit 242 for use when the auxiliary unit 200 is set as a sound detection unit 14, an electrical detection circuit 243 for use when the auxiliary unit 200 is set as an electrical detection unit 16 and an external device controlling circuit 246 for use when the auxiliary unit 200 is set as an external device controlling unit 22. The logic functions of the auxiliary unit 200 are quite similar to the ones of the personal unit 12 except for the input/output (I/O) management. The input circuits (input module 20 vs. sound detection circuit 242 and electrical detection circuit 243) are different and the auxiliary unit 200 has no output module 18, no vibrator 142, and no speaker 143. Accordingly, the auxiliary unit 200 comprises a transceiver 240 for transmitting event messages in response to the detection of events from its input circuits, i.e. the sound detection circuit 242 and the electrical detection circuit 243, and for repeating event messages received from other units, a CPU 244 for managing the operation of the various components, an indicating light 256, typically a light emitting diode (LED), for indicating that the auxiliary unit 200 has been activated by an event, a programming input 258, e.g. a push button, for use in the learning mode of the personal unit 12 to add the auxiliary unit 200 to the system 10, and a power supply 260 for powering each of its components.

The transceiver 240, the CPU 244 and the configuration register 248 are typically of the same model as the ones used in the personal unit 12 and operate similarly.

When set as a sound detection unit 14, the auxiliary unit 200 can be used for detecting baby cries for example using the sound detection circuit 242. The sound detection circuit 242 comprises a microphone 262 sensitive to any sound in its surroundings and a threshold adjustment 264. The auxiliary unit 200 (used as a sound detection unit 14) is activated when a threshold is reached and the sound is maintained for a given period, typically three seconds (raw sound). When the auxiliary unit 200 is activated, the transceiver 240 sends a sound event message comprising the ID code 250 of the auxiliary unit 200 and the indicating light 256 is switched on. The auxiliary unit 200 remains activated until it receives an acknowledgment message from a personal unit 12 and then sends back a confirmation that the acknowledgment was received. If the auxiliary unit 200 receives no acknowledgement within thirty seconds, the event is cancelled and the transceiver 240 stops to send the sound event message.

The electrical detection circuit 243 is for use with an electrical device such as a door bell, a fire alarm, a smoke detector, a motion detector or any other electrical warning device. It is used for detecting dry contacts closure of an infrared motion detector or the presence of a voltage on a door bell circuit for example. The electrical detection circuit 243 comprises a dry contact input 266 and an AC/DC voltage input 268 for accommodating different types of electrical devices. The electrical device is connected to the appropriate input 266 or 268 and input 266 or 268 to which the electrical device is connected is selected automatically by an input selector 270. The electrical device connected to the dry contact input 266 or the AC/DC voltage input 268 is monitored for activation. The transmission of an electrical event is similar to the transmission of a sound event. It is noted that the electrical devices can also be provided with integrated electrical detection units 16.

Finally, the electrical output dry contacts can be used to turn on or off an external appliance through an approved electrical interface for example. The external device controlling circuit 246 comprises a set of single pole double throw (SPDT) output dry contacts 272, 274 and 276 to control external devices. Switching between dry contacts pairs 272-274 and 274-276 is controlled by a switch control circuit 278.

It will be understood that the sound detection unit 14, the electrical detection unit 16 and the device controlling unit 22 may also each have a different electrical design rather than being different configurations of the same auxiliary unit 200. The sound detection unit 14 would then include a sound detection circuit 242 but no electrical detection circuit 243 and no external device controlling circuit 246.

FIG. 5 illustrates a bedside unit 24 for use in the environmental sensing system 10. The bedside unit 24 is used to wake the user when he/she is in bed in case of a detected event. The bedside unit 24 comprises a transceiver 340 for receiving messages, a bed vibrator 342 and an intense lamp 352 for warning the user of the reception of a message, an alarm clock display 354 for displaying the time and programming a clock alarm, a CPU 344 for managing the operation of the various components, a configuration register 348 for saving the system configuration and a power supply 360 for powering each component of the sound detection unit 14. The bedside unit 24 is similar in construction to the personal unit 12 but it has no output module 18 and it is not designed to be worn by the user. Furthermore, its vibrator, i.e. the bed vibrator 342, is external and adapted to be installed in the bed. The intense light 352 is also provided to help in waking the user.

The transceiver 340 and the CPU 344 are typically of the same model as the ones used in the personal unit 12 and operate similarly.

The intense lamp 352 is typically a stroboscopic lamp consisting of five white LEDs and five red LEDs facing a wall of the bedroom and producing a light that is likely to wake the user.

If an alarm is set using the alarm clock 354 using the five push buttons 330 of the input module 320, the bedside unit 24 is activated by the alarm clock at the time of the alarm. The speaker 353 sounds a continuous tone and the bedside unit 24 activates both the bed vibrator 342 and the white LEDs of the intense lamp 352 to wake up the user in the bed. If an emergency event is received by the transceiver 340 (an event detected by a fire detector for example), the bed vibrator 342 is activated with a rapid pulsing pattern, the speaker 353 is activated with a rapid pulsing tone, and the intense lamp 352 is activated with an alternating white/red strobe effect.

In one embodiment, an electrical detection unit 16 for detecting a phone ring is combined with the bedside unit 24. This equipment, without the bed vibrator 342, can also be used elsewhere in the house or at work to notify the user of a phone ring using an intense lamp 352.

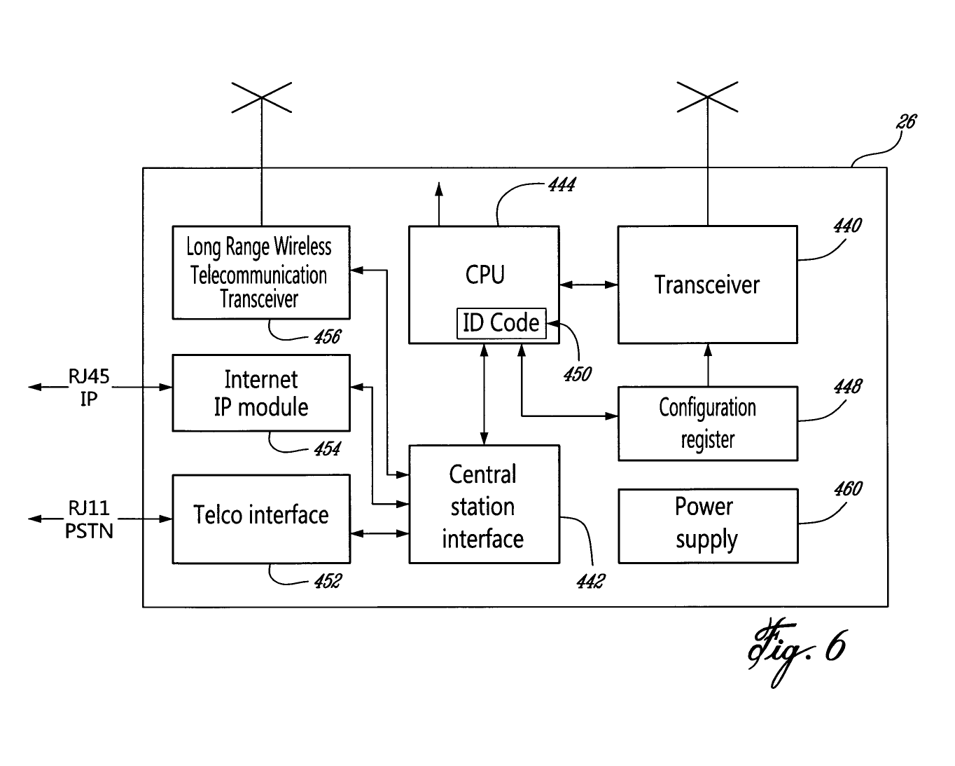

FIG. 6 illustrates a central station interfacing unit 26 for use in the environmental sensing system 10. The central station interfacing unit 26 comprises a transceiver 440 for receiving immediate assistance requests and messages directed to the central station and for transmitting messages received from the central station to the personal unit 12. It also comprises a CPU 444 for managing the operation of the various components, a configuration register 448, a power supply 460 and a central station interface 442. The central station interface 442 transmits messages to and receives messages from the central station using either a Telco interface 452 for phone line communication, an internet protocol module 454, i.e. a network card, for internet communication or a long range wireless telecommunication transceiver 456.

In this embodiment, the transceivers of all the units of the environmental sensing system 10 are commercially available digital radio modem transceivers which communicate using a wireless private network IEEE 802.15.4 available within the coverage zone of the environmental sensing system 10. The digital radio modems operate in the 2405 to 2475 MHz range and provide an operating range of up to 1500 m. The network works in a pear-to-pear configuration as opposed to a master-slave configuration. This allows the system to be split apart, i.e. some units may be separated and transported away from the others and both separated parts of the system may operate independently.

When an event is detected by a sound detection unit 14 or an electrical detection unit 16, the detection unit 14 or 16 is activated and sends a corresponding event message using its transceiver 240 until an acknowledgment of receipt is received from one of the personal units 12. The event message includes the ID code 250 of the detection unit 14 or 16 sending the message. A personal unit 12 receiving the message first checks if the ID code in the message is registered in its configuration register 248. The personal unit 12 only considers the message if the ID code is registered in its configuration register 248. Accordingly, all personal units 12 and bedside units 24 in the communication range of the detection unit 14, 16 receive the event message but only units registered in the system 10 will actually consider the message. If the message is considered, detection is notified on the personal unit 12 by activating the vibrator 142 and displaying the icon associated with the ID code in the configuration register 148 on the output module 18. The user then needs to hold top button 5 for two seconds in order to acknowledge receipt of the message. The personal unit 12 then sends an acknowledgement message using its transceiver 140. The acknowledgement message includes the ID code 150 of the personal unit 12 sending the acknowledgement message but also the ID code 250 of the detection unit to which the acknowledgement message is addressed, i.e. the detection unit 14 or 16 that generated the event. The detection unit 14 or 16 receives the acknowledgement message and checks whether it is received from a unit that is registered in its configuration register 248 and whether the acknowledgement message is addressed to it. The detection unit 14 or 16 then cancels the event. The detection unit 14 or 16 also sends a confirmation of the receipt of the acknowledgement. When receiving the acknowledgement, the personal units 12 and bedside units 24 disable the icon on the output module 18 or clock display 354 and deactivate the vibrator 142 or 342. An “OK” icon is also displayed briefly. If no acknowledgement of receipt of the event message is received by the detection unit 14 or 16, it will automatically cancel the event after thirty seconds in order to save power. The icon and vibrator 142 or 342 are also cancelled after thirty seconds when the detection unit 12 or 14 stops sending an event message.

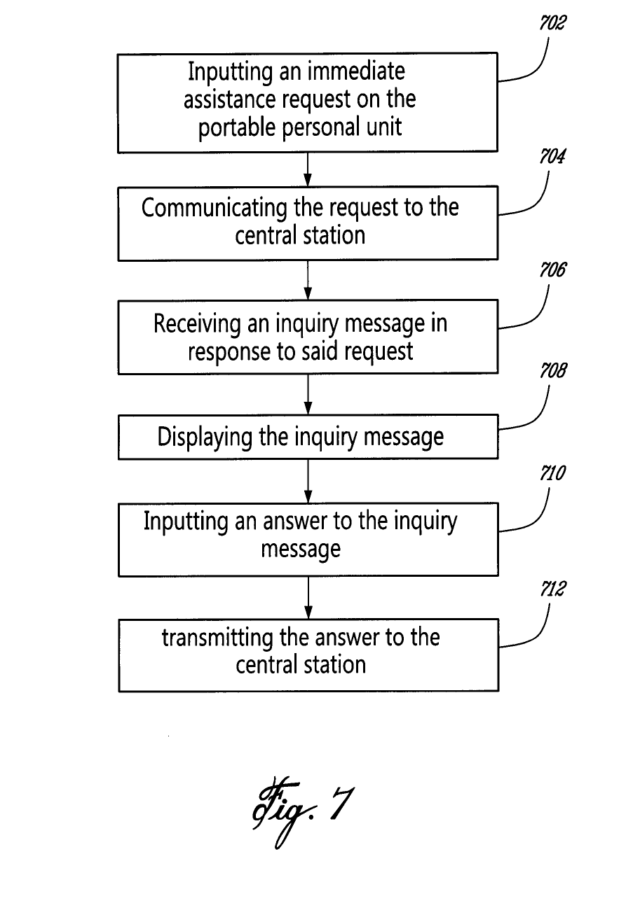

FIG. 7 illustrates a method carried on in the personal unit 12 when a user wishes to send an immediate assistance request using his/her personal unit 12. In step 702, the user inputs the immediate assistance request by pressing button 2 or button 3 if the request is a medical assistance request on the personal unit 12. In step 704, the request is communicated to the central station through the central station interfacing unit 26, using the transceiver 140. The central station then receives the request and may ask confirmation or further details to the user through his/her personal unit 12. The central station than outputs a inquiry message in response to the request. The inquiry message is transmitted to the personal unit 12 through the central station interfacing unit 26. In step 706, the inquiry message is received on the personal unit 12 using the transceiver 140. In step 708, the inquiry message is displayed on the output module 18, typically as a text message displayed on the display screen. In step 710, the user inputs an answer to the inquiry message using the push buttons 1,2,3,4,5 of the input module 20. In step 712, the answer is transmitted to the central station through the central station interfacing unit 26. The central station can send other inquiry messages to the personal unit 12 if necessary or can send an affirmative message to confirm to the user that an appropriate measure is being undertaken. The central station may also communicate updates to the user while resources are being deployed.

The following procedure is used to add or replace an auxiliary unit 200 used as a sound detection unit 14, an electrical detection unit 16 or a device controlling unit 22, in the environment sensing system 10. This adding/replacing procedure uses a personal unit 12 or a bedside unit 24 as the input device to the environment sensing system 10. The user holds the programming input button 258 of the new auxiliary unit 200 for about five seconds. The indicating light 256 then turns on, which indicates that the new auxiliary unit 200 is activated and transmits a message including its unique ID code. The user then holds button 4 of its personal unit 12 or bedside unit 24 for about five seconds. The personal unit 12 or the bedside unit 24 then listens to any message, including messages from units not already listed in the configuration register 148 and finds out than the new auxiliary unit 200 needs to be registered. When the new auxiliary unit 200 is identified, the personal unit 12 or bedside unit 24 displays the “OK” icon on the output module 18 or clock display 354. The user may then scroll the icons to select an appropriate icon to be associated to the new auxiliary unit 200 using buttons 1 to 4 and confirms the selection using button 5. The user may then select a reference numeral to be associated to the new auxiliary unit 200 to differentiate between two or more units having the same function, and thus the same icon (multiple door bells for example). The ID code 250 of the new auxiliary unit 200 is then saved in the configuration register 148 or 348 of the personal unit 12 or the bedside unit 24, along with its associated icon and reference numeral. When completed, the new auxiliary unit configuration information is broadcasted to all units within the environment sensing system 10, including all personal units 12 if more than one is used. When the addition of the new auxiliary unit 200 in the system is successful, the indicating light 256 flashes. The user may verify the communication between the new auxiliary unit 200 and the personal unit 12 or the bedside unit 24 by pressing the programming input button 258 twice. The icon associated with the new detection device should appear on the output module 18 of the personal unit 12 or on the clock display 354 of the bedside unit 24.

The same procedure is used to remove an existing auxiliary unit 14 from the system 10 for replacement. If the procedure is used to remove an existing auxiliary unit 14, an extra query is displayed on the output module 18 of the personal unit 12 or the clock display 354 of the bedside unit 24, asking for confirmation (YES or NO) to delete the existing auxiliary unit 200 information from the configuration register 148,348. This extra query makes the difference between a unit to be “added” or “removed”.

The next procedure is used to add or replace a personal unit 12. The user uses the input module 20 to initiate the programming sequence by holding simultaneously buttons 1 and 4 of the new personal unit. The new personal unit is then activated and transmits a message including its unique ID code. The user then uses in input module 20 or 320 to activate the programming mode of the old personal unit 12 or the bedside unit 24 by holding button 4 of an old personal unit 12 or the bedside unit 24 for about five seconds. The old personal unit 12 or bedside unit 24 then listens to any message, including messages from units not already listed in the configuration register 148 and receives the message from the new personal unit. It thus finds out that the new personal unit 12 needs to be registered. When the new personal unit 12 is identified, the old personal unit or bedside unit 24 displays the “OK” icon on its output module 18. The user may then scroll the icons to select an appropriate icon (most probably the icon of FIG. 3G) to be associated to the new personal unit using buttons 1 to 4 and confirms the selection using button 5. The ID code 150 of the new personal unit 12 is then saved in the configuration register 148 or 348 of the old personal unit 12 or bedside unit 24, along with its associated icon and reference numeral. When completed, the data content of the updated configuration register 148 or 348 is broadcasted to all units within the environment sensing system 10, including the new personal unit and all other personal units 12 if more than one is used. All units registered in the system 10 are then saved in the configuration register of the new personal unit 12 so that it can recognize messages from any unit of the system 10. If the addition of the new personal unit 12 is successful, the “OK” icon is displayed on the output module of the new personal unit.

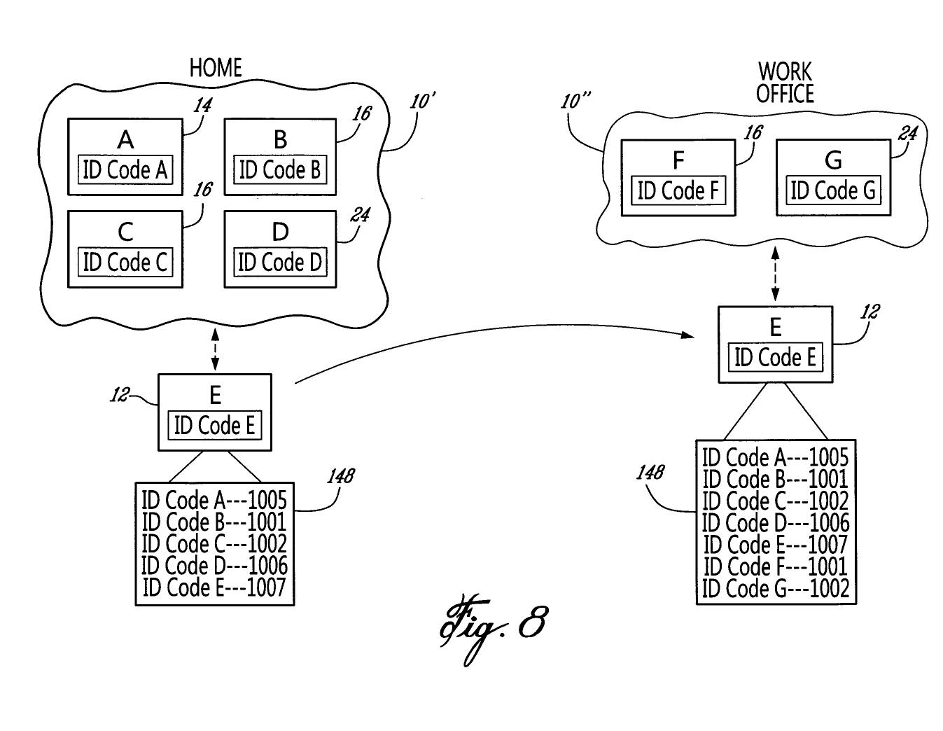

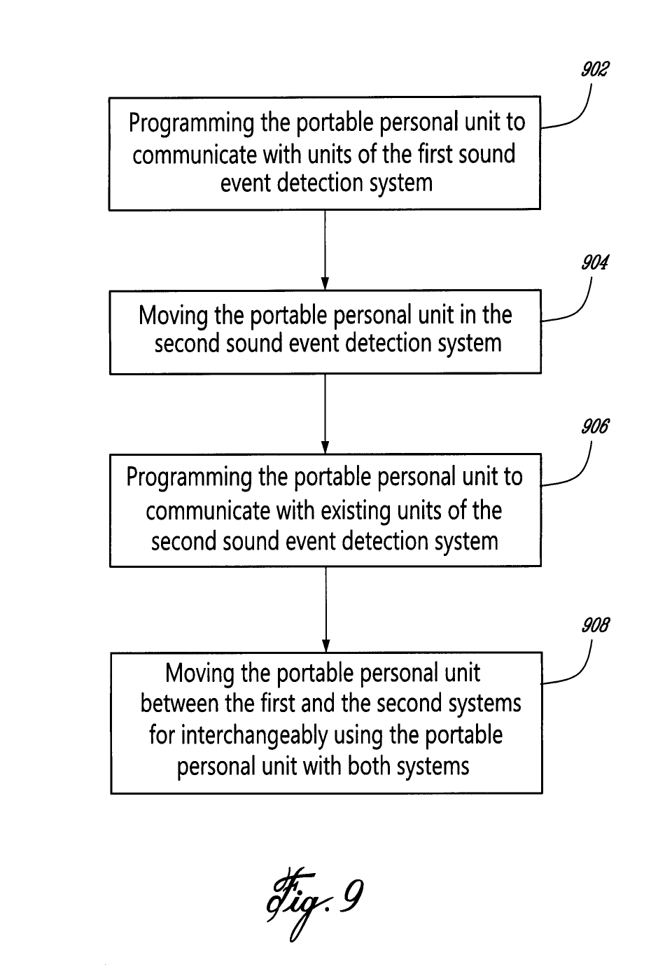

FIGS. 8 and 9 illustrates the programming of a personal unit 12 to function in a plurality of environment sensing systems 10′ and 10″, e.g. a system 10′ at home and a system 10″ at work for example, using the last described procedure. The procedure is used to add a second system 10″ to a personal unit 12 which is already registered in a first system 10′. In step 902, the personal unit 12 is first programmed to communicate with units of the first system 10′, including sound detection unit A, electrical detection units B, C and bedside unit D. The personal unit 12 can be preprogrammed in manufacture to communicate with system 10′ for example. The personal unit 12 can also have been later added to the system 10′. In any case, the configuration register 148 of the personal unit 12 includes all units A, B, C, D and E registered in the system 10′. When the user goes to work with his/her personal unit 12, he/she may want his/her personal unit 12 to also work with the second system 10″ located at work. The personal unit 12 can be added to a second system 10″ by moving it the surrounding environment of the system 10″, step 904 and registering it in the system 10″. In step 906, registering is performed using the above described procedure which adds the units F, G of the system 10″ in the configuration register 148 of the personal unit 12, while the units A, B, C, D, E of the system 10′ are kept. The new personal unit 12 is then allowed to recognize units from both the first and the second systems 10. In step 908, the personal unit 12 can then be carried between the surrounding environments of systems 10′ and 10″ for interchangeably using the personal unit 12 with either system 10′ or system 10″. It is noted that, similarly, a personal unit can be programmed to communicate with more than two systems 10.

The same procedure is also used to remove an existing personal unit 14 from the system 10 for replacement. If the procedure is used to remove an existing personal unit 12 or bedside unit 24, an extra query is displayed on the output module 18 of the personal unit 12, or the clock display 354 of the bedside unit 24 asking for confirmation (YES or NO) to delete the existing unit information from the configuration register 148, 348. When completed, the new unit configuration information is broadcasted to all units within the environment sensing system 10, including all personal units 12 if more than one is used.

It is noted that when a sound event detection system 10 is purchased, the configuration register 148, 248, 348 and 448 of all units 12, 14, 16, 22, 24, 26 and 28 are typically set at manufacture to work all together. More units can be purchased later and programmed according to the above procedures, in order to work in the same system 10.

It is noted that each unit may additionally comprise an optional sound detector. The optional sound detector and the sound detection circuit 242 of the auxiliary unit 200 may also have a sound recognition circuit for identifying different possible sounds in the surrounding environment. The sound recognition circuit may learn various sounds such as a phone ring, a door bell, a fire alarm, baby cries, a drying machine signal, a microwave oven signal, etc. The sound detector is then activated by any of programmed sound and an icon is associated to each programmed sound.

In one embodiment, the sound detection circuit 242 and the external device controlling circuit 246 of the auxiliary unit 200 are replaced by a miniature CCD color video camera which is used to transmit an image through the transceiver 240. By using this version of the auxiliary unit as a front door bell detector, the personal unit 12 receives the image and displays it on the output module 18. The user wearing a personal unit 12 can then visually identify the visitor right away. Furthermore, one or more similar auxiliary unit can be used as part of the security system when an infrared sensor is connected to its electrical detector input.

In another embodiment, the transceiver 140 of the personal unit comprises a long-range wireless telecommunication (LRWT) transceiver, such as a transceiver adapted for cellular telecommunications, for the personal unit to communicate directly with the central station. Consequently, the personal unit is not required to be at home to request immediate assistance to the central station. Using the LRWT transceiver, the central station and the personal unit can therefore bi-directionally communicate and exchange information, inquiries and answers without involving a fixed central interfacing unit, the central station interface being integrated in the portable personal unit. This allows the user to request immediate assistance anywhere between the house and the workplace or while traveling. The input and output modules may then be used for the user to communicate its location to the central station or the personal unit may include a global positioning system (GPS) in communication with the LRWT transceiver for the location of the user to be automatically communicated to the central station.

It is contemplated that the environmental sensing system could find applications beyond the hearing-impaired. Similar systems could be used for remote monitoring for example. In industrial applications, sound detection units could be replaced by equipment monitoring units and/or gas detection units for example for warning a watchman of an equipment failure or malfunction. The watchman could then receive a warning on a personal unit and a central station could be advised and could communicate with the watchman through his personal unit.

Other handicapped people, such as the blind or the physically handicapped, could also benefit from the personal unit in communication with a central station for requesting assistance. In this case, sound detection units could be substituted with intrusion detection units for example. The personal unit could then be used for the central station and the user to easily communicate wherever the user is located in the house or workplace. The personal unit could then further comprise a microphone and a speaker for establishing voice communication between the user and the central unit.

While illustrated in the block diagrams as groups of discrete components communicating with each other via distinct data signal connections, it will be understood by those skilled in the art that the preferred embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

The embodiments of the invention described above are intended to be exemplary only. The scope of the invention is therefore intended to be limited solely by the scope of the appended claims.

What is claimed is:

1. A personal unit for notifying a deaf/hearing-impaired user of a sound event in its surrounding environment and for communicating an immediate assistance request to a central station, said personal unit comprising:
a transceiver for receiving a sound event message representative of said sound event detected in said environment,
an output module for notifying said user of said sound event message, and
an input module for inputting said immediate assistance request, said request to be communicated to said central station using said transceiver;
said transceiver being further for receiving an inquiry message initiated by said central station in response to said request,
said output module being further for displaying said inquiry message, and
said input module being further for inputting an answer to said inquiry message, said answer to be communicated to said central station using said transceiver.

2. The personal unit as claimed in claim 1, further comprising a vibrator activated upon reception of said sound event message for warning said user said reception.

3. The personal unit as claimed in any one of claim 1, wherein said output module comprises a display screen for displaying an icon representative of said sound event message.

4. The personal unit as claimed in claim 1, wherein said output module comprises a display screen and said inquiry message comprises a text to be displayed on said display screen.

5. The personal unit as claimed in claim 1, wherein said input module comprises buttons for selecting the answer to be inputted.

6. The personal unit as claimed in claim 1, wherein said input module comprises an immediate assistance button for inputting the immediate assistance request by pressing said button.

7. The personal unit as claimed in any one of claims 1 to 6, wherein said sound event is one of a door bell detection event, a fire alarm detection event, a phone ring detection event, a sound detection event and a baby cry detection event.

8. A method for communicating an immediate assistance request to a central station using a portable personal unit for notifying a deaf/hearing-impaired user of a sound event in its surrounding environment, the method comprising:
receiving, on the portable personal unit, a sound event message representative of said sound event detected in said environment;
providing a notification of said sound event message on the portable personal unit;
inputting an immediate assistance request on the portable personal unit;
communicating said request to said central station;
receiving an inquiry message initiated by said central station in response to said request, on the portable personal unit;
displaying said inquiry message on the portable personal unit;
manually inputting an answer to said inquiry message on said portable personal unit; and
transmitting said answer to said central station.

9. The method as claimed in claim 8, wherein said providing a notification of said sound event message comprises displaying an icon representative of said sound event message on said portable personal unit.

10. The method as claimed in any one of claims 8 and 9, wherein said providing a notification of said sound event message comprises activating a vibrator for warning said user of the reception of said sound event message.

11. The method as claimed in claim 8, wherein said communicating said request comprises:
transmitting said request to a central station interfacing unit located in the surrounding environment of the portable personal unit, using a transceiver; and
said central station interfacing unit transmitting said request to said central station.

12. The method as claimed in claim 11, wherein said central station interfacing unit transmitting said request to said central station is made using a wired technology.

13. The method as claimed in claim 12, wherein said central station interfacing unit transmitting said request to said central station is made using a central station phone line.

14. The method as claimed in claim 8, wherein said receiving an inquiry message comprises:
receiving said inquiry message on a central station interfacing unit located in the surrounding environment of the portable personal unit;
said central station interfacing unit transmitting said request to the portable personal unit; and
receiving said inquiry message on the portable personal unit.

15. The method as claimed in claim 8, wherein said displaying said inquiry message on the portable personal unit comprises displaying a text inquiry message on a display screen.

16. The method as claimed in claim 8, wherein said manually inputting an answer comprises pressing a button associated with the answer, on said portable personal unit.

17. The method as claimed in claim 8, wherein said inputting an immediate assistance request on the portable personal unit comprises pressing a button on said portable personal unit.

18. The method as claimed in any one of claims 8 to 17, wherein said sound event is one of a door bell detection event, a fire alarm detection event, a phone ring detection event, a sound detection event and a baby cry detection event.

19. A portable personal unit for notifying a deaf/hearing-impaired user of a sound event in its surrounding environment and in communication with a detection unit having a unique identification code, said personal unit comprising:
a register for listing registered identification codes,
a transceiver for receiving a sound event message representative of a sound event detected in said environment, said sound event message comprising said unique identification code and said transceiver considering said sound event message only if said unique identification code is listed in said register,
an output module for providing a notification of the considered sound event message, and
an input module for adding and removing registered identification codes from said register.

20. The personal unit as claimed in claim 19, wherein said output module comprises a screen for displaying an icon associated in said register to said unique identification code.

21. A method for using a portable personal unit with at least a first and a second sound event detection systems, the personal unit for notifying a deaf/hearing-impaired user of sound events in its surrounding environment, the method comprising:
programming the portable personal unit to communicate with units of the first sound event detection system;
moving the portable personal unit in a surrounding environment of the second sound event detection system, the first and the second sound event detection systems having non-overlapping surrounding environments;
programming the portable personal unit to communicate with existing units of the second sound event detection system such that the portable personal unit is remained allowed to communicate with units of the first sound event detection system; and
moving the portable personal unit between the surrounding environments of the first and the second sound event detection systems for interchangeably using the portable personal unit with the first and the second sound event detection systems.

22. The method as claimed in claim 21, further comprising:
while the portable personal unit is in the surrounding environment of one of the first and the second sound event detection systems, receiving on the personal unit a sound event message representative of a sound event detected in said one of the first and the second sound event detection systems; and
providing a notification of said sound event message on the portable personal unit.

23. The method as claimed in any one of claims 21 and 22, wherein each of the existing units of said second sound event is associated with a unique identification code and has a configuration register comprising the unique identification code of all existing units, and wherein said programming the portable personal unit to communicate with the existing units of the second sound event detection system comprises:
activating an input module of the portable personal unit for initiating the programming procedure;
the portable personal unit transmitting a message comprising the unique identification code of the portable personal unit in response to said activating;
activating a programming mode of one of the existing units;
the one existing unit receiving said message and adding the unique identification code of the portable personal unit in its configuration register;
said one existing unit transmitting its modified configuration register;
other ones of the existing units and the portable personal unit receiving the modified configuration register;
said other ones of the existing units updating their configuration register so as to include the unique identification code of the portable personal unit; and
the portable personal unit modifying its configuration register so as to include the unique identification code of all existing units.

24. The method as claimed in claim 23, further comprising:
while the portable personal unit is in the surrounding environment of the second sound event detection system, receiving on the personal unit a sound event message representative of a sound event detected by an activated one of the existing units, the sound event message comprising the unique identification code of the activated one of the existing units;
the portable personal unit considering the sound event message only if the unique identification code in the sound event message is included in its configuration register; and
providing a notification of said sound event message on the portable personal unit if the sound event message is considered.
